(19) United States
(12) Patent Application Publication
(10) Pub. No.: US 2025/0006400 A1
(43) Pub. Date: Jan. 2, 2025

(54) POWER TOOLS WITH A CURRENT CONDUCTOR, AND ENERGY SUPPLY DEVICE

(71) Applicant: Hilti Aktiengesellschaft, Schaan (LI)

(72) Inventors: Robert STANGER, Kaufbeuren (DE); Markus HARTMANN, Mauerstetten (DE); Stefan HEROLD, Muenchen (DE); Jaouher BELTAIEF, Augsburg (DE)

(21) Appl. No.: 18/708,669

(22) PCT Filed: Nov. 11, 2022
(86) PCT No.: PCT/EP2022/081602

§ 371 Date: May 9, 2024

(30) Foreign Application Priority Data
Dec. 1, 2021 (EP) 21211575.2
Jan. 11, 2022 (EP) 22150869.0

(51) Int. Cl. H01B 1/02; H01M 50/247

(52) U.S. Cl. CPC H01B 1/026; H01M 50/247; H01M 2220/30

(57) ABSTRACT

A power tool, wherein the power tool has at least one current conductor, wherein a circumference U of the at least one current conductor is greater than two and a half times the square root of the product of a cross-sectional area A of the at least one current conductor and pi π. The at least one current conductor can include a series of individual current conductors, wherein the circumference U of the at least one current conductor corresponds to the enveloping circumference of the individual current conductors, and wherein the cross-sectional area A of the at least one current conductor can be formed from the sum of the cross-sectional areas of the individual current conductors. The power tool can be connected to an energy supply device in order to be supplied with electrical energy. An energy supply device for use in a power tool, i.e. for supplying a power tool with electrical energy.

### FIELD OF THE INVENTION

The present invention relates to a power tool, wherein the power tool has at least one current conductor. In a second aspect, the invention relates to an energy supply device for use in a power tool according to the invention, i.e. for supplying a power tool according to the invention with electrical energy.

### BACKGROUND OF THE INVENTION

So-called cordless power tools, for example cordless screwdrivers, drills, saws, grinders, or the like, may be connected to an energy supply device for energy supply purposes. The energy supply device may for example be configured as or comprise a rechargeable battery. Rechargeable batteries usually have a multiplicity of energy storage cells, also known as rechargeable battery cells, by means of which electrical energy may be received, stored and released again. If the rechargeable battery is connected to a power tool, the electrical energy stored in the energy storage cells may be fed to the loads (e.g. a brushless electric motor) of the power tool. For charging purposes, i.e. for loading the energy storage cells with electrical energy, the rechargeable battery is connected to a charging device, such as a charger, so that electrical energy can reach the energy storage cells.

### SUMMARY OF THE INVENTION

High electrical loads can occur when transmitting electrical energy. However, not all power tools have an identical or similar power requirement, i.e. the electrical loads can vary depending on the energy and/or power requirement of the power tool. In order to cope with these high electrical loads, which may vary depending on the power requirement of the power tool, the invention is intended to provide a current conductor for a power tool that withstands the high electrical loads and can also be used to transmit very large constant currents in a region of 50 amperes (A), preferably more than 70 A or most preferably more than 100 A.

For example, DE 10 2014 217 987 A1 discloses a rechargeable battery pack for a power tool, wherein the rechargeable battery pack can be mechanically and/or electrically connected to the power tool via an interface.

US 2020 0127 339 A1 describes a battery pack and an electrical apparatus that can be supplied with electrical energy via the battery pack. In the event of a contact failure, charging or discharging of the battery pack may be interrupted after a fault signal has been sent.

An object on which the present invention is based is to overcome the shortcomings and disadvantages of the prior art and to provide a power tool having such a current conductor that withstands particularly high electrical loads. In addition, it is a concern of the invention to provide an energy supply device which can be connected to the power tool and which is able to provide correspondingly large constant currents for the power tool.

The invention provides a power tool having at least one current conductor, wherein a circumference U of the at least one current conductor is greater than two and a half times the square root of the product of a cross-sectional area A of the at least one current conductor and pi π. The at least one current conductor is preferably present in an interior or interior space of the power tool, which can preferably be surrounded by a housing and delimited on the outside. The at least one current conductor is configured in particular to connect components of the power tool in an electrically conductive manner, so that currents can flow between the components of the power tool. These currents can preferably be constant currents and can be in a region of 50 amperes (A), preferably more than 70 A, and most preferably more than 100 A. Advantageously, the invention can be used to provide a power tool capable of handling high currents, i.e. a power tool which, due to its current conductors, is capable of handling and withstanding such high constant currents well without thermal overloads or other impairments occurring. In particular, the invention can be used to specify a current conductor that is optimized in terms of heat dissipation or thermal properties, with the good thermal properties of the current conductor resulting in particular from the optimized ratio of line cross section to line circumference of the current conductor.

The wording that a circumference U of the at least one current conductor is greater than two and a half times the square root of the product of a cross-sectional area A of the at least one current conductor and pi π can be used to mean, for example, those current conductors which have a non-circular cross-sectional area. For example, such current conductors with a non-circular cross-sectional area can be formed by busbars which are arranged in the interior of the power tool and are configured to transmit electrical energy between the components of the power tool.

In the context of the invention, it is very particularly preferred that the current conductor is used to connect components of the power tool. In particular, the current conductor can be used to connect components of the power tool, such as the electronics, the motor and/or the interface to the energy supply device, to each other. The fact that the current conductor is used in particular to transmit electrical energy inside the power tool is evident from FIGS. 2 and 3, for example. In particular, the current conductor of the power tool according to the invention is not a contact plate of the interface between the power tool and the energy supply device, and, in particular, the current conductor of the power tool according to the invention is also not a plug-in contact which can be used to transmit electrical energy from the energy supply device to the power tool. Rather, the current conductor of the power tool according to the invention is in the interior of the power tool and is configured there to transmit or conduct electrical energy between the components of the power tool.

In the context of the invention, it is very particularly preferred that the power tool according to the invention is a DC-operated power tool. In the context of the invention, the term “DC-operated” is understood as meaning that a corresponding power tool is supplied with electrical energy-preferably direct current-preferably via a battery or a rechargeable battery. In this way, the power tool can be operated independently of a power supply system, which in particular facilitates the use of the power tool on a construction site. In addition, by means of the invention, it is possible to dispense with a wired connection of the power tool to a power supply system.

Such currents can preferably be provided with an energy supply device according to the invention. The power tool is thus optimally able to deal with such large currents and to distribute currents of the order of magnitude mentioned in the power tool or to direct them to the individual components. In order to distribute or forward the currents, the power tool comprises the at least one current conductor, the circumference U of which is greater than two and a half times the square root of the product of a cross-sectional area A of the at least one current conductor and pi π.

If the power tool is connected to the energy supply device, current or electrical energy can be transmitted from the energy supply device to the power tool. The current or electrical energy preferably reaches the power tool via an interface, wherein the interface has female and/or male contact partners or contact plugs through which the current can flow. The at least one current conductor in the power tool is preferably configured to connect the interface between the power tool and the energy supply device to other components inside the power tool. These further components can be, for example, control and/or power electronics of the power tool or its motor, which constitutes an electrical load in the context of the power tool.

The power tool has at least one current conductor having a circumference U that is greater than two and a half times the square root of the product of a cross-sectional area A of the at least one current conductor and pi π. It goes without saying that the power tool can also have more than one such current conductor. In the context of the invention, it can be preferred that the components of the power tool are each electrically connected to a current conductor. However, it may just as well be preferred that more than one such current conductor is arranged between the components of the power tool in order to connect the respectively involved components of the power tool to one another in an electrically conductive manner. For example, two current conductors can be provided in each case in order to be arranged, for example, between the electronics, the motor and/or the interface of the power tool.

The at least one current conductor has a circumference U that is greater than two and a half times the square root of the product of a cross-sectional area A of the at least one conductor and pi π. In particular, the circumference U of the at least one current conductor can be expressed by the following relationship:

$$U > 2.5 \cdot √ ( A \cdot π ) ,$$

the letter “A” stands for the cross-sectional area or cross section of the current conductor. In the context of the invention, it is preferred that only the current-carrying or current-conducting regions are taken into account for the cross-sectional area of the current conductor and that any insulation is not taken into account. In other words, when determining the cross-sectional area of the current conductor in a sectional representation, only the current-carrying regions and areas are taken into account, but any insulation regions or insulation areas that may be present are preferably not taken into account. If the current conductor comprises copper or a copper alloy as the current-carrying material, the copper or copper-containing regions can be viewed in the sectional representation as the cross-sectional area A of the current conductor. In the context of the invention, it is preferred that the terms “cross-sectional area A” and “cross section A” are used synonymously. Pi π is 3.1416 to a good approximation, with pi and how to use it being known to a person skilled in the art.

The inventors have recognized that current conductors that satisfy the stated relationship are particularly well suited to being used in power tools to conduct currents or electrical energy. Surprisingly, it has been shown that such current conductors withstand the high currents, which can be provided by a energy supply device, particularly well without resulting in thermal damage to the current conductor or its insulation. The invention can provide current conductors which have a particularly favorable ratio of circumference U to cross-sectional area A. As a result, the heat dissipation of the current conductor to its surrounding area can be significantly improved compared to conventional current conductors, as are known from the prior art, so that unwanted heat can be dissipated particularly well from the region of the current conductor. Consequently, the invention can be used to provide a power tool that has a significantly improved current-carrying capacity and is particularly resistant to thermal overloads due to the improved heat dissipation of its current conductors.

The at least one current conductor can be in the form of a stranded wire, for example. The current conductor can be single-core or multi-core, or it can also include insulation. The insulation may include plastic or be formed from plastic. If the current conductor is multi-core, the current conductor can comprise a plurality of individual conductors. The cross-sectional area A in the above relationship, which characterizes the current conductor, is then preferably formed from the sum of the cross-sectional areas A_i of the individual conductors. If the current conductor comprises, for example, two individual conductors having a cross-sectional area A_1=1 mm² and A_2=2 mm², the cross-sectional area A of the current conductor would be A=3 mm² in this example. In the context of the present invention, the individual conductor is preferably regarded as the smallest, inseparable individual unit or sub-unit of a current conductor. In the context of the invention, it is preferred that the cross-sectional area A of the at least one current conductor can be formed from the sum of the cross-sectional areas of the individual current conductors: A=A_ges=Σ A_i. In the case of a single-core current conductor, the cross-sectional area A preferably corresponds to the cross-sectional area A of the one individual conductor that forms the single-core current conductor.

In the case of a current conductor that is formed from a plurality of individual conductors, the circumference U in the above relationship, which characterizes the current conductor, preferably corresponds to the enveloping circumference of the individual current conductors. The enveloping circumference can preferably be formed by virtue of the fact that the outermost points of the bundle of individual conductors are connected to one another substantially directly, i.e. tangentially. The enveloping circumference can be viewed in particular as the length of a line, with the line enclosing the area of the current-carrying individual stranded wires in a sectional representation. Examples of the enveloping circumference of a multi-core current conductor are shown in FIG. 5. In the case of a single-core current conductor, the enveloping circumference preferably corresponds to the circumference of the one individual conductor that forms the single-core current conductor.

The cross-sectional area A of the current conductor can have a substantially circular basic shape. However, the cross-sectional area A of the current conductor can also have any other conceivable geometric shape. For example, the cross-sectional area A of the current conductor can have a rectangular, square, elliptical, triangular, polygonal, diamond-shaped or trapezoidal base area, without being limited thereto. Different possibilities for designing the current conductor are illustrated in FIGS. 4a, 4b and 4c.

In the context of the invention, it is preferred that the at least one current conductor has a current-carrying capacity I, the current-carrying capacity I of the at least one current conductor being greater than twenty-two times the expression A\hat{ }0.65, where A is the cross-sectional area of the at least one current conductor. The relationship |>22· A\hat{ }0.65 or |>22·A^{0.65} applies in particular if the cross-sectional area of the at least one current conductor is specified in square millimeters (mm²) and the current-carrying capacity I in amperes (A). In the context of the invention, it is preferred that the power tool comprises at least one current conductor which has a current conductivity of greater than twenty-two times the expression A\hat{ }0.65.

In the context of the invention, it is preferred that the cross-sectional area A of the at least one current conductor is in a range of 1.65 mm² to 10.25 mm². Tests have shown that, above all, current conductors with cross-sectional areas in the range mentioned have particularly advantageous thermal properties. The at least one current conductor can in particular have copper or be formed from copper.

In the context of the invention, it is preferred that the power tool can be connected to an energy supply device in order to be supplied with electrical energy. Preferably, the energy supply device can also have a current conductor, the circumference U of which is greater than two and a half times the square root of the product of a cross-sectional area A of the at least one current conductor and pi π. In the context of the invention, it can also be preferred that the energy supply device has at least one current conductor, wherein the at least one current conductor has a current-carrying capacity I that is greater than twenty-two times the expression A\hat{ }0.65, where A is the cross-sectional area of the at least one current conductor.

In the context of the invention, it is preferred that the energy supply device and the power tool form a working system in which the energy supply device supplies the power tool with electrical energy. The power tool can preferably have a current conductor having the properties mentioned, wherein it is particularly preferred in the context of the invention that the current conductor is in the interior of the power tool and connects the components of the power tool to one another there. In other words, the invention also relates to a working system that includes a power tool and an energy supply device, wherein the power tool in particular comprises at least one current conductor having the properties mentioned. The current conductor can preferably be a current conductor with a non-circular base area, such as a busbar, the circumference U of which is greater than two and a half times the square root of the product of a cross-sectional area A of the current conductor and pi π.

Advantageously, the invention can be used to provide a system for supplying power tools with electrical energy, wherein the system comprises a power tool and an energy supply device. With the system, high constant currents in a region of 50 A, preferably more than 70 A, or most preferably more than 100 A, can be transmitted from the energy supply device to the power tool and can be distributed there to the components and loads inside the power tool. For this purpose, the power tool and/or the energy supply device has/have current conductors, the circumference U of which is greater than two and a half times the square root of the product of a cross-sectional area A of the at least one current conductor and pi π. Alternatively, it is possible to use current conductors, the current-carrying capacity I of which satisfies the relationship |>22· A\hat{ }0.65 or |>22·A^{0.65}.

The energy supply device can preferably comprise at least one rechargeable battery, wherein the energy supply device is configured to supply the power tool with electrical energy. Electrical energy is output from the energy supply device to the power tool in particular in the connected state in which the power tool is connected to the energy supply device via an interface. The interface or the connection partners involved “power tool” and “energy supply device” can have female and male contact partners, wherein the female and male contact partners engage with one another in the connected state in such a way that electrical current or electrical energy can flow via a contact region between the connection partners.

The energy supply device is preferably an energy supply device which is configured to output particularly high currents, in particular constant currents of more than 50 amperes, preferably more than 70 amperes, and most preferably more than 100 amperes.

In the context of the invention, it is preferred that the energy supply device comprises at least one cell, wherein the at least one cell has an internal resistance DCR_I of less than 10 milliohms (mohm). In preferred configurations of the invention, the internal resistance DCR_I of the at least one cell can be less than 8 milliohms and preferably less than 6 milliohms. Here, the internal resistance DCR_I is preferably measured in accordance with standard IEC61960. The internal resistance DCR_I represents, in particular, the resistance of a cell of the energy supply device, wherein possible components or accessories of the cell do not make any contribution to the internal resistance DCR_I. A low internal resistance DCR_I is advantageous since in this way absolutely no undesired heat, which has to be dissipated, is produced. The internal resistance DCR_I is, in particular, a DC resistance which can be measured in the interior of a cell of the energy supply device. The internal resistance DCR_I can of course also assume intermediate values such as 6.02 milliohms; 7.49 milliohms; 8.33 milliohms; 8.65 milliohms or 9.5 milliohms.

It has been found that, with the internal resistance DCR_I of the at least one cell of less than 10 milliohms, it is possible to provide an energy supply device which has particularly good thermal properties in the sense that it can be operated particularly well at low temperatures, wherein the cooling expenditure can be kept surprisingly low. In particular, an energy supply device with a cell internal resistance DCR-I of less than 10 milliohms is particularly well suited to supplying electrical energy to particularly powerful power tools. Such energy supply devices can therefore make a valuable contribution to allowing rechargeable battery-operated power tools to be used even in those areas of application which were previously assumed by experts to be inaccessible to rechargeable battery-operated power tools.

Advantageously, such an energy supply device can make it possible to supply a battery-operated or rechargeable battery-operated power tool having an energy supply device according to the invention with a high output power over a long period of time, without damaging the surrounding plastic components or the cell chemistry within the cells of the energy supply device.

In the context of the invention, it is preferred that a ratio of a resistance of the at least one cell to a surface area A_Z of the at least one cell is less than 0.2 milliohm/cm², preferably less than 0.1 milliohm/cm² and most preferably less than 0.05 milliohm/cm². In the case of a cylindrical cell, the surface of the cell can be formed, for example, by the outer surface of the cylinder as well as the top side and the bottom side of the cell. In the context of the invention, it can also be preferred that a ratio of a resistance of the at least one cell to a volume V_Z of the at least one cell is less than 0.4 milliohm/cm³, preferably less than 0.3 milliohm/cm³ and most preferably less than 0.2 milliohm/cm³. For conventional geometric shapes, such as cuboids, cubes, spheres or the like, a person skilled in the art knows the formulae for calculating the surface area or the volume of such a geometric body. In the context of the invention, the term “resistance” preferably denotes the internal resistance DCR_I which can preferably be measured in accordance with standard IEC61960. This is preferably a DC resistance.

It is preferred in the context of the invention that the at least one cell has a heating coefficient of less than 1.0 W/(Ah·A), preferably less than 0.75 W/(Ah·A) and particularly preferably of less than 0.5 W/(Ah·A). Furthermore, the at least one cell can be designed to output a current of greater than 1000 amperes/liter substantially constantly. The discharge current is indicated in relation to the volume V_Z of the at least one cell, wherein the space measurement unit “liter” (I) is used as the unit for the volume. The cells according to the invention are therefore able to output a discharge current of substantially constantly greater than 1000 A per liter of cell volume. In other words, a cell with a volume of 1 liter is able to output a substantially constant discharge current of greater than 1000 A, wherein the at least one cell furthermore has a heating coefficient of less than 1.0 W/(Ah·A). In preferred configurations of the invention, the at least one cell of the energy supply device can have a heating coefficient of less than 0.75 W/(Ah·A), preferably less than 0.5 W/(Ah·A). The unit for the heating coefficient is watts/(ampere hours·amperes). The heating coefficient can of course also have intermediate values, such as 0.56 W/(Ah·A); 0.723 W/(Ah·A) or 0.925 W/(Ah·A).

The invention advantageously makes it possible to provide an energy supply device having at least one cell which exhibits reduced heating and therefore is particularly well suited to supplying power tools in which high powers and high currents, preferably constant currents, are desired for operation. In particular, the invention can be used to provide an energy supply device for a power tool in which the heat which is optionally created during operation of the power tool and when outputting electrical energy to the power tool can be dissipated in a particularly simple and uncomplicated manner. Tests have shown that the invention can not only be used to more effectively dissipate existing heat. Rather, the invention prevents heat being generated or the quantity of heat generated during operation of the power tool can be considerably reduced using the invention. The invention can advantageously be used to provide an energy supply device which can supply electrical energy in an optimum manner primarily also to power tools which have stringent requirements in respect of power and discharge current. In other words, the invention can provide an energy supply device for particularly powerful power tools with which heavy drilling or demolition work can be performed on construction sites for example.

In the context of the invention, the term “power tool” should be understood as meaning a typical piece of equipment that can be used on a construction site, for example a building construction site and/or a civil engineering construction site. They may be hammer drills, chisels, core drills, angle grinders or cut-off grinders, cutting devices or the like, without being restricted thereto. In addition, auxiliary devices such as those occasionally used on construction sites, such as lamps, radios, vacuum cleaners, measuring devices, construction robots, wheelbarrows, transport devices, feed devices or other auxiliary devices can be “power tools” in the context of the invention. The power tool may in particular be a mobile power tool, wherein the energy supply device may also be used in particular in stationary power tools, such as frame-mounted drills or circular saws. However, preference is given to hand-held power tools that are, in particular, operated by rechargeable battery or battery.

It is preferred in the context of the invention that the at least one has a temperature cooling half-life of less than 12 minutes, preferably less than 10 minutes, particularly preferably less than 8 minutes. In the context of the invention, this preferably means that, with free convection, a temperature of the at least one cell is halved in less than 12, 10 or 8 minutes. The temperature cooling half-life is preferably determined in an inoperative state of the energy supply device, that is to say when the energy supply device is not in operation, that is to say is not connected to a power tool. Energy supply devices with temperature cooling half-lives of less than 8 mins have primarily been found to be particularly suitable for use in powerful power tools. The temperature cooling half-life can of course also have a value of 8.5 minutes, 9 minutes 20 seconds or of 11 minutes 47 seconds.

Owing to the surprisingly low temperature cooling half-life of the energy supply device, the heat generated during operation of the power tool or when it is charging remains within the at least one cell only for a short time. In this way, the cell can be recharged particularly quickly and is rapidly available for re-use in the power tool. Moreover, the thermal loading on the components of the energy supply device or the power tool having the energy supply device can be considerably reduced. As a result, the energy supply device can be preserved and its service life extended.

In the context of the invention, it is preferred that the at least one cell is arranged in a battery pack of the energy supply device. A series of individual cells can preferably be combined in the battery pack and in this way inserted into the energy supply device in an optimum manner. For example, 5, 6 or 10 cells can form a battery pack, with integer multiples of these numbers also being possible. For example, the energy supply device can have individual cell strings which can comprise, for example, 5, 6 or 10 cells. An energy supply device having, for example, three strings of five cells each can comprise, for example, 15 individual cells.

In the context of the invention, it is preferred that the energy supply device has a capacity of at least 2.2 Ah, preferably at least 2.5 Ah. Tests have shown that the capacity values mentioned are particularly well suited to the use of powerful power tools in the construction industry and meet the requirements there for the availability of electrical energy and the possible service life of the power tool particularly well.

The at least one cell of the energy supply device is preferably configured to deliver a discharge current of at least 20 A for at least 10 s. For example, a cell of the energy supply device may be designed to provide a discharge current of at least 20 A, in particular at least 25 A, for at least 10 s. In other words, the at least one cell of an energy supply device can be configured to provide a continuous current of at least 20 A, in particular at least 25 A.

It is also conceivable that peak currents, in particular short-term peak currents, may lead to strong heating of the energy supply device. Therefore an energy supply device with powerful cooling, as can be achieved by the measures described here, is particularly advantageous. It is conceivable, for example, that the at least one cell of the energy supply device can provide at least 50 A for 1 second. In other words, it is preferred in the context of the invention that the at least one cell of the energy supply device is configured to provide a discharge current of at least 50 A for at least 1 s. Power tools can often require high powers for a short period of time. An energy supply device with cells able to deliver such a peak current and/or such a continuous current may therefore be particularly suitable for powerful power tools as are used on construction sites.

It is preferred in the context of the invention that the at least one cell comprises an electrolyte, wherein the electrolyte is preferably present in a liquid physical state at room temperature. The electrolyte can comprise lithium, sodium and/or magnesium, without being restricted thereto. In particular, the electrolyte can be lithium-based. As an alternative or in addition, said electrolyte can also be sodium-based. It is also conceivable for the rechargeable battery to be magnesium-based. The electrolyte-based energy supply device can have a rated voltage of at least 10 V, preferably at least 18 V, in particular of at least 28 V, for example 36 V. A rated voltage in a range of from 18 to 22 V, in particular in a range of from 21 to 22 V, is very particularly preferred. The at least one cell of the energy supply device can have, for example, a voltage of 3.6 V, without being restricted thereto.

It is preferred in the context of the invention that the energy supply device is charged, for example, at a charging rate of 1.5 C, preferably 2 C, and most preferably 3 C. A charging rate of ×C can be understood as meaning the current intensity which is required to fully charge a discharged energy supply device in a fraction of an hour corresponding to the digit x of the charging rate x C. For example, a charging rate of 3 C makes it possible to fully charge the rechargeable battery within 20 minutes.

It is preferred in the context of the invention that the at least one cell of the energy supply device has a surface area A_Z and a volume V_Z, wherein a ratio A_Z/V_Z of surface area to volume is greater than six times, preferably eight times, and particularly preferably ten times, the reciprocal of the cube root of the volume.

The expression that the surface area A_Z of the at least one cell is greater than, for example, eight times the cube root of the square of the volume V_Z can preferably also be expressed by the formula A_Z>8*(V_Z)\hat{ }(⅔). Written another way, this relationship can be described by the fact that the ratio (A_Z)/(V_Z) of surface area to volume is greater than eight times the reciprocal of the cube root of the volume.

In order to check whether the above relationship is satisfied, values in the same basic unit must always be used. For example, if a value for the surface area in m² is inserted into the above formula, a value in the unit m³ is preferably inserted for the volume. For example, if a value for the surface area in the unit cm² is inserted into the above formula, a value in the unit cm³ is preferably inserted for the volume. For example, if a value for the surface area in the unit mm² is inserted into the above formula, a value in the unit mm³ is preferably inserted for the volume.

Cell geometries which, for example, satisfy the relationship of

A_Z>8*(V_Z)\hat{ }(⅔) advantageously have a particularly favorable ratio between the outer surface of the cell, which is decisive for the cooling effect, and the cell volume. The inventors have recognized that the ratio of surface area to volume of the at least one cell of the energy supply device has an important influence on the removal of heat from the energy supply device. The improved cooling capacity of the energy supply device can advantageously be achieved by increasing the cell surface area for a constant volume and a low internal resistance of the at least one cell. It is preferred in the context of the invention for a low cell temperature given a simultaneously high power output to preferably be able to be rendered possible when the internal resistance of the cell is reduced. Reducing the internal resistance of the at least one cell can result in less heat being generated. In addition, a low cell temperature can by using cells in which the surface area A_Z of at least one cell within the energy supply device is greater than six times, preferably eight times, and particularly preferably ten times, the cube root of the square of the volume V_Z of the at least one cell. As a result, in particular the output of heat to the surrounding area can be improved.

It has been found that energy supply devices with cells which satisfy said relationship can be significantly better cooled than previously known energy supply devices with, for example, cylindrical cells. The above relationship can be satisfied, for example, by virtue of the fact that, although the cells of the energy supply device have a cylindrical basic shape, additional elements that increase the surface area are arranged on the surface thereof. Said elements can be, for example, fins, teeth or the like. Cells which do not have a cylindrical basic shape, but rather are shaped entirely differently, can also be used within the scope of the invention. For example, the cells of the energy supply device can have a substantially cuboidal or cube-like basic shape. The term “substantially” is not unclear to a person skilled in the art here because a person skilled in the art knows that, for example, a cuboid with indentations or rounded corners and/or edges should also be covered by the term “substantially cuboidal” in the context of the present invention.

In the context of the invention, it is preferred that the energy supply device comprises at least one energy storage cell, wherein the energy supply device is configured to output a maximum constant current of greater than 50 amperes, preferably greater than 70 amperes, most preferably greater than 100 amperes. The maximum constant current output is the quantity of current of a cell or an energy supply device that can be drawn without the cell or the energy supply device reaching an upper temperature limit. Possible upper temperature limits can lie in a region of 60° C. or 70° C., without being restricted thereto. The unit for the maximum constant current output is amperes.

All intermediate values should also always be considered to be disclosed in the case of all the value ranges that are mentioned in the context of the present invention. For example, values of between 50 and 70 A, that is to say 51, 62.3, 54, 65.55 or 57.06 amperes etc. for example, should also be considered to be disclosed in the case of the maximum constant current output. Furthermore, values of between 70 and 100 A, that is to say 72, 83.3, 96, 78.55 or 98.07 amperes for example, should also be considered to be disclosed.

It is preferred in the context of the invention for the energy supply device to have a discharge C rate of greater than 80·t\hat{ }(−0.45), where the letter “t” stands for time in the unit seconds. The C rate advantageously allows quantification of the charging and discharge currents for energy supply devices, wherein the discharge C rate used here renders possible, in particular, the quantification of the discharge currents of energy supply devices. For example, the maximum permissible charging and discharge currents can be indicated by the C rate. These charging and discharge currents preferably depend on the rated capacity of the energy supply device. The unusually high discharge C rate of 80·t\hat{ }(−0.45) advantageously means that the energy supply device can be used to achieve particularly high discharge currents which are required for operating powerful power tools in the construction industry. For example, the discharge currents can lie in a region of greater than 50 amperes, preferably greater than 70 amperes or even more preferably greater than 100 amperes.

In the context of the invention, it is preferred that the cell has a cell temperature gradient of less than 10 Kelvin. The cell temperature gradient is preferably a measure of temperature differences within the at least one cell of the energy supply device, wherein it is preferred in the context of the invention that the cell has a temperature distribution that is as uniform as possible, that is to say that a temperature in an inner region of the cell differs as little as possible from a temperature which is measured in the region of a lateral or outer surface of the cell.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form useful further combinations.

Identical and similar components are denoted by the same reference signs in the figures,

in which:

FIG. 1 shows a schematic sectional representation of a preferred configuration of the energy supply device

FIG. 2 shows a schematic sectional representation of a power tool with a preferred configuration of the energy supply device

FIG. 3 shows a schematic sectional representation of a preferred configuration of the power tool

FIGS. 4a, 4b, and 4c show schematic sectional representations of possible preferred configurations of the current conductor

FIGS. 5 and 5b show examples of a current conductor to clarify the term “enveloping circumference”.

### DETAILED DESCRIPTION

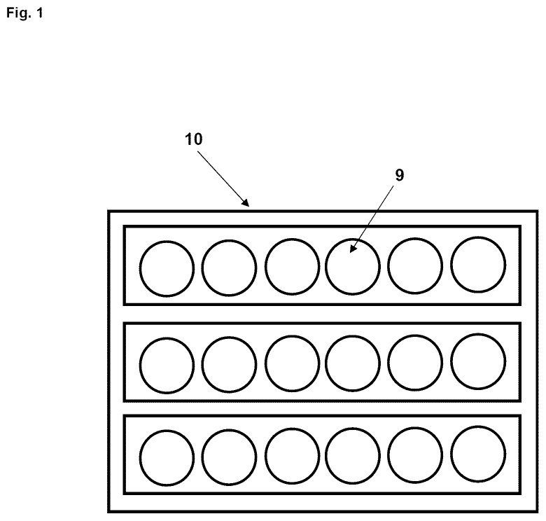

FIG. 1 shows a schematic sectional representation of a preferred configuration of the energy supply device 10. The energy supply device 10 illustrated in FIG. 1 has eighteen energy storage cells 9, wherein the eighteen cells 9 are arranged in three strings within the energy supply device 10. In particular, the cells 9 are symbolized by the circles, while the strings are symbolized by the elongated rectangles surrounding the circles (“cells 9”).

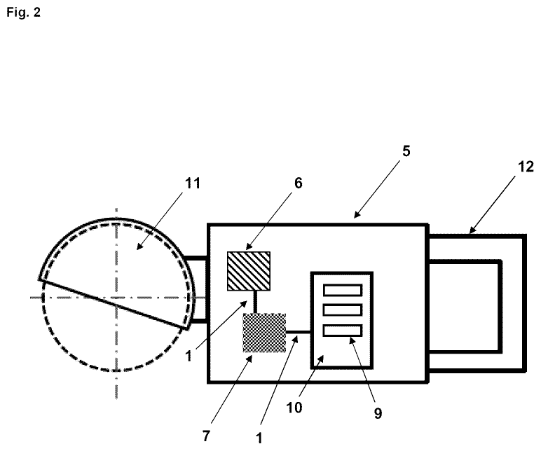

FIG. 2 shows a schematic view of a power tool 5 having a energy supply device 10. The power tool 5 can be, for example, a cut-off grinder that has a cut-off wheel as the tool 11. The power tool 5 can have a handle 12 which is designed, for example, as a rear handle. In addition, the power tool 5 can have a motor 6, electronics 7 and/or an energy supply device 10, wherein the motor 6, the electronics 7 and/or the energy supply device 10 can be connected to one another via a current conductor 1.

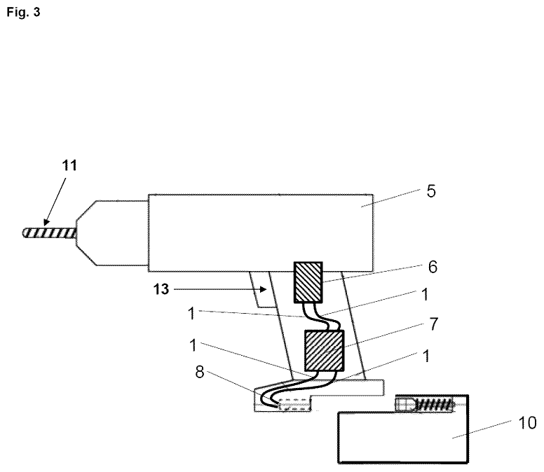

FIG. 3 shows a schematic sectional representation of a preferred configuration of the power tool 5. The power tool 5 has a tool 11, wherein the tool 11 can be a drill, for example. The power tool 5 can be switched on or off by means of an operating element 13. The power tool 5 can also be connected to an energy supply device 10 in order to draw electrical energy from the energy supply device 10 or to be supplied with electrical energy by the energy supply device 10. The power tool 5 can have a motor 6, electronics 7 and/or an interface 8, wherein the interface 8 is configured to connect the power tool 5 to the energy supply device 10. In particular, a mechanical and an electrical connection can be established between the power tool 5 and the energy supply device 10 by means of the interface 8. The components of the power tool 5, i.e. the motor 6, the electronics 7 and the interface 8, can be connected to one another by current conductors 1. For example, current conductors 1 can be provided between the motor 6 and the electronics 7 or between the electronics 7 and the interface 8 of the power tool 5. The current conductors 1 are preferably configured such that electric currents can flow between the components 6, 7, 8 of the power tool 5. Consequently, the current conductors 1 establish an electrical connection between the components 6, 7, 8 of the power tool 5. Of course, other components of the power tool 5 can also be connected to one another by means of the current conductors 1. For example, a direct electrical connection can also be provided by a current conductor 1 between the interface 8 and the motor 6 of the power tool 5.

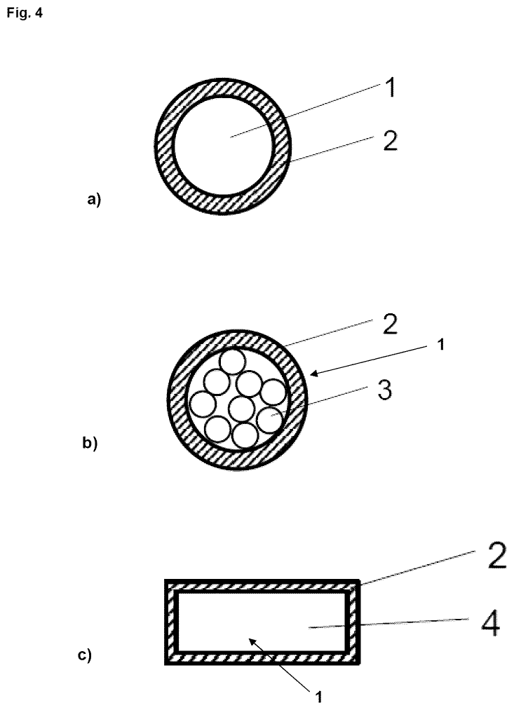

Possible configurations of the current conductor 1 are illustrated in FIGS. 4a, 4b and 4c. For example, FIG. 4a shows a single-core current conductor 1 with insulation 2. In this context, the wording “single-core” should be understood as meaning that the current conductor 1 is formed solidly from a strand of metal, for example copper. Deviating from this, a current conductor 1 that comprises a series of individual conductors 3 is shown in FIG. 4b. The individual conductors 3 can be thin copper wires, for example, which are arranged inside insulation 2. The individual conductors 3 can be twisted within the insulation 2, for example. Current conductors 1 which comprise a plurality of individual conductors 3 can preferably be referred to as “multi-core” in the context of the invention. The current conductor 1, which is installed in the power tool 5, can also have a non-circular cross-sectional area, for example. Such a current conductor 4 with a non-circular cross-sectional area is illustrated in FIG. 4c. In contrast, the current conductor 1 in FIGS. 4a and 4b has a substantially circular cross-sectional area.

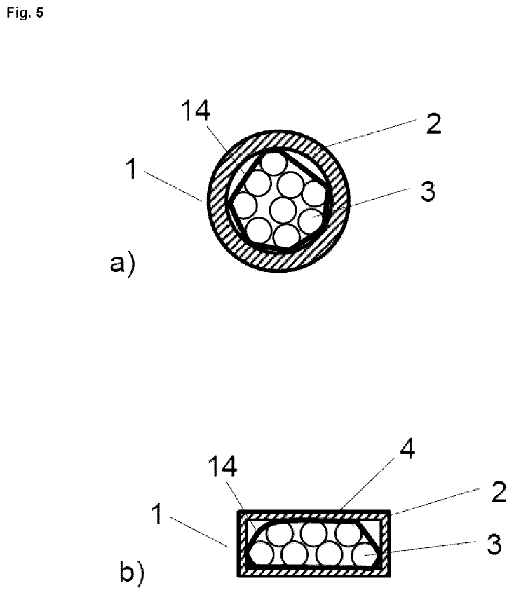

FIGS. 5a and 5b illustrate examples of a current conductor 1 to clarify the term “enveloping circumference” 14. FIG. 5a shows a current conductor 1 with a cross-sectional area A that is substantially circular in a sectional representation. The current conductor 1 shown in FIG. 5a has nine individual conductors 3 which are surrounded by insulation 2. In particular, FIGS. 5a and 5b show the enveloping circumference 14 which surrounds the outer points of the bundle of individual conductors 3 like a taut envelope. The enveloping circumference 14 is preferably present between a shrink tube, which can be placed around the bundle of individual conductors 3, and an inside of the optional insulation 2. The enveloping circumference 14 preferably has a length or represents a length, this length corresponding to the length of a connecting line of the outermost points of the bundle of individual conductors 3.

FIG. 5b shows a current conductor 1 with a cross-sectional area A, the cross-sectional area A being substantially non-circular. The current conductor 4 shown in FIG. 5b has in particular a rectangular cross-sectional area A in a sectional representation. The current conductor 4 shown in FIG. 5b has seven individual conductors 3 which are surrounded by insulation 2. In addition, FIG. 5b shows the enveloping circumference 14 which surrounds the bundle of individual conductors 3.

### LIST OF REFERENCE SIGNS

1 Current conductor
2 Optional: insulation
3 Individual current conductor
4 Current conductor with non-circular cross section
5 Power tool
6 Motor of the power tool
7 Electronics of the power tool
8 Interface of the power tool for receiving an energy supply device
9 Cell of an energy supply device
10 Energy supply device
11 Tool of the power tool
12 Handle of the power tool
13 Operating element of the power tool, e.g. switch
14 Enveloping circumference

What is claimed is:

1-15: (canceled)

16: A power tool comprising:
at least one current conductor, a circumference U of the at least one current conductor being greater than two and a half times the square root of the product of a cross-sectional area A of the at least one current conductor and pi.

17: The power tool as recited in claim 16 wherein the at least one current conductor has a current-carrying capacity I, the current-carrying capacity I of the at least one current conductor being greater than twenty-two times the expression A\hat{ }0.65.

18: The power tool as recited in claim 16 wherein the at least one current conductor includes a series of individual current conductors, wherein the circumference U of the at least one current conductor corresponds to an enveloping circumference of the individual current conductors, and wherein the cross-sectional area A of the at least one current conductor is formed from the sum of the cross-sectional areas of the individual current conductors.

19: The power tool as recited in claim 16 wherein the cross-sectional area A of the at least one current conductor is in a range of 1.65 mm² to 10.25 mm².

20: The power tool as recited in claim 16 wherein the at least one current conductor has insulation.

21: The power tool as recited in claim 16 wherein the at least one current conductor has copper.

22: The power tool as recited in claim 16 wherein the at least one current conductor has a non-circular cross-sectional area A.

23: The power tool as recited in claim 16 wherein the power tool is connectable to an energy supply device in order to be supplied with electrical energy.

24: The power tool as recited in claim 23 wherein the at least one current conductor is configured to connect a motor, electronics or an interface for receiving the energy supply device.

25: An energy supply device for use in the power tool as recited in claim 16, the energy supply device comprising at least one energy storage cell, wherein the at least one energy storage cell has an internal resistance DCR_I of less than 10 milliohms.

26: An energy supply device for use in the power tool as recited in claim 16, the energy supply device comprising at least one energy storage cell, wherein the at least one energy storage cell has a surface area A_Z and a volume V_Z, wherein a ratio (A_Z)/(V_Z) of surface area to volume is greater than six times a reciprocal of the cube root of the volume.

27: The energy supply device as recited in claim 26 wherein the ratio is greater than eight times the reciprocal of the cube root of the volume.

28: The energy supply device as recited in claim 26 wherein the ratio is greater than ten times the reciprocal of the cube root of the volume.

29: An energy supply device for use in the power tool as recited in claim 16, the energy supply device comprising at least one energy storage cell, wherein a ratio of a resistance of the at least one energy storage cell to a surface area A_Z of the at least one cell (2) is less than 0.2 milliohm/cm².

30: The energy supply device as recited in claim 26 wherein the ratio is less than less than 0.1 milliohm/cm².

31: The energy supply device as recited in claim 26 wherein the ratio is less than 0.05 milliohm/cm².

32: An energy supply device for use in the power tool as recited in claim 16, wherein the energy supply device has a capacity of at least 2.2 Ah.

33: The energy supply device as recited in claim 32 wherein the energy supply device has a capacity of at least 2.5 Ah.

34: An energy supply device for use in the power tool as recited in claim 16, the energy supply device comprising at least one current conductor, wherein a circumference U of the at least one current conductor is greater than two and a half times the square root of the product of a cross-sectional area A of the at least one current conductor and pi.

35: An energy supply device for use in the power tool as recited in claim 16, the energy supply device comprising at least one current conductor, wherein the at least one current conductor has a current-carrying capacity I that is greater than twenty-two times the expression A\hat{ }0.65, where A is the cross-sectional area of the at least one current conductor.
